(19) United States
(12) Patent Application Publication
(10) Pub. No.: US 2026/0362496 A1
(43) Pub. Date: Nov. 12, 2026

(54) ORDERED CONTENTION BASED RANDOM ACCESS FOR A CANDIDATE CELL

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/153,570

(22) PCT Filed: Apr. 5, 2023
(86) PCT No.: PCT/CN2023/086358

§ 371 Date: Aug. 4, 2025

(51) Int. Cl. H04W 74/0833

(52) U.S. Cl. CPC H04W 74/0833

(57) ABSTRACT

Certain aspects of the present disclosure provide techniques for ordered contention based random access for a candidate cell. An example method, performed at a wireless node, includes obtaining a signal indicating the wireless node is to transmit a physical random access channel (PRACH) to a candidate cell, selecting a synchronization signal (SS) index for the candidate cell, and outputting the PRACH, for transmission, using resources associated with the selected SS index.

### BACKGROUND

### Field of the Disclosure

Aspects of the present disclosure relate to wireless communications, and more particularly, to techniques for ordered contention based random access for a candidate cell.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communication at a wireless node. The method includes obtaining a signal indicating the wireless node is to transmit a physical random access channel (PRACH) to a candidate cell; selecting a synchronization signal (SS) index for the candidate cell; and outputting the PRACH, for transmission, using resources associated with the selected SS index.

Another aspect provides a method of wireless communication at a first wireless node. The method includes outputting a signal indicating a second wireless node is to transmit a physical random access channel (PRACH) to a candidate cell; and obtaining the PRACH using resources associated with a synchronization signal (SS) index for the candidate cell selected by the second wireless node.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a call flow diagram for a 4-step random access channel (RACH) procedure.

FIG. 6 depicts an example of UE mobility.

FIG. 7 depicts an example scenario with a pre-configured candidate cell set.

FIG. 8 depicts an example scenario with a pre-configured candidate cell set and a physical downlink control channel (PDCCH) order.

FIG. 9 depicts a call flow diagram illustrating ordered contention based random access for a candidate cell, in accordance with certain aspects of the present disclosure.

FIG. 10 depicts an example scenario with a pre-configured candidate cell set and a physical downlink control channel (PDCCH) order, in accordance with certain aspects of the present disclosure.

FIG. 11 depicts a first example of a contention based random access (CBRA) physical random access channel (PRACH) transmission triggered by a PDCCH order, in accordance with certain aspects of the present disclosure.

FIG. 12 depicts a second example of a contention based random access (CBRA) physical random access channel (PRACH) transmission triggered by a PDCCH order, in accordance with certain aspects of the present disclosure.

FIG. 13 depicts a third example of a contention based random access (CBRA) physical random access channel (PRACH) transmission triggered by a PDCCH order, in accordance with certain aspects of the present disclosure.

FIG. 14 depicts a method for wireless communications.

FIG. 15 depicts a method for wireless communications.

FIG. 16 depicts aspects of an example communications device.

### DETAILED DESCRIPTION

Aspects of the present disclosure provide apparatuses, methods, processing systems, and computer-readable mediums for ordered contention based random access (CBRA) physical random access channel (PRACH) transmissions from a wireless node on candidate cells.

In advanced wireless systems, mobility procedures are in place to help maintain network connections for a user equipment (UE) as it moves between the coverage areas of different cells. Mobility procedures generally refer to mechanisms that allow a UE to transition from being served by a source cell to being served by a target cell.

In some cases, for physical layer (PHY or Layer 1/L1) and/or medium access control layer (MAC or Layer 2/L2), also referred to as L1/L2 triggered mobility (LTM), as a UE moves, a new serving cell (e.g. a primary cell (Pcell)) may be selected (e.g., reselected) among a set of pre-configured candidate cells based on L1 measurement for those cells. To save timing advance (TA) acquisition time, a UE may send a PRACH to a target candidate cell for TA measurement before it is selected as a new serving cell.

In some systems only PRACH transmissions triggered (ordered) via a physical downlink control channel (PDCCH) may be allowed in a candidate cell for LTM. In such cases, the PDCCH ordered PRACH transmission may be contention free, using a RACH occasion (RO) for an SSB index indicated in the PDCCH order. In some cases, however, a contention based random access (CBRA) PRACH transmission may be useful.

For example, if a network has less knowledge of a synchronization signal block (SSB) that would be appropriate for a PRACH, it may be better for a CBRA PRACH to be transmitted based on a UE-selected SSB. CBRA procedures may encounter multiple UEs transmitting in the same RO. To resolve this contention, a random access response (RAR), sent after a PRACH, may provide contention resolution information. Unfortunately, certain systems may not be configured for RAR. Thus, CBRA PRACH transmissions may have collision issue among different UEs, without resolution.

Aspects of the present disclosure provide techniques for supporting CBRA PRACH transmissions in LTM scenarios. In some cases, contention resolution information may be provided, even in systems not configured for RAR. By utilizing techniques proposed herein, CBRA based PRACH transmissions based on UE selected SSBs may be used, which may improve LTM mobility and quality of experience (QoE) of users.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

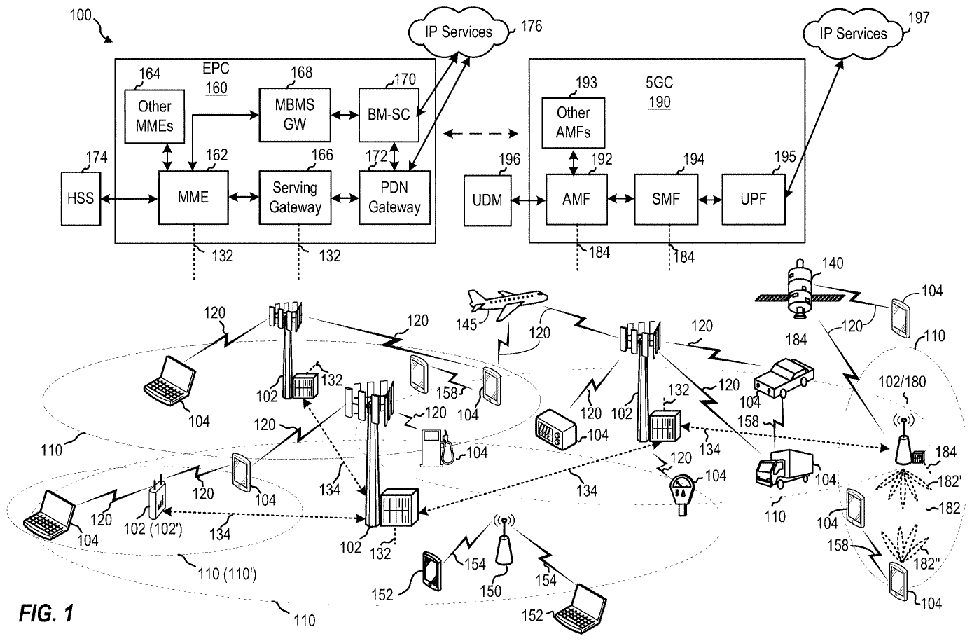

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

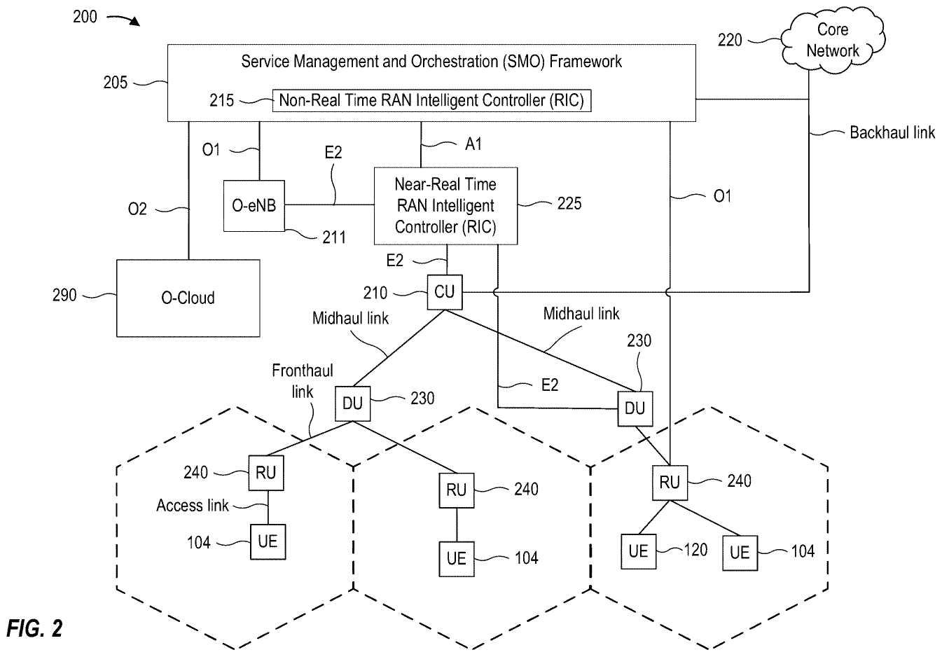

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mm Wave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an Ol interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an Ol interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as Al policies).

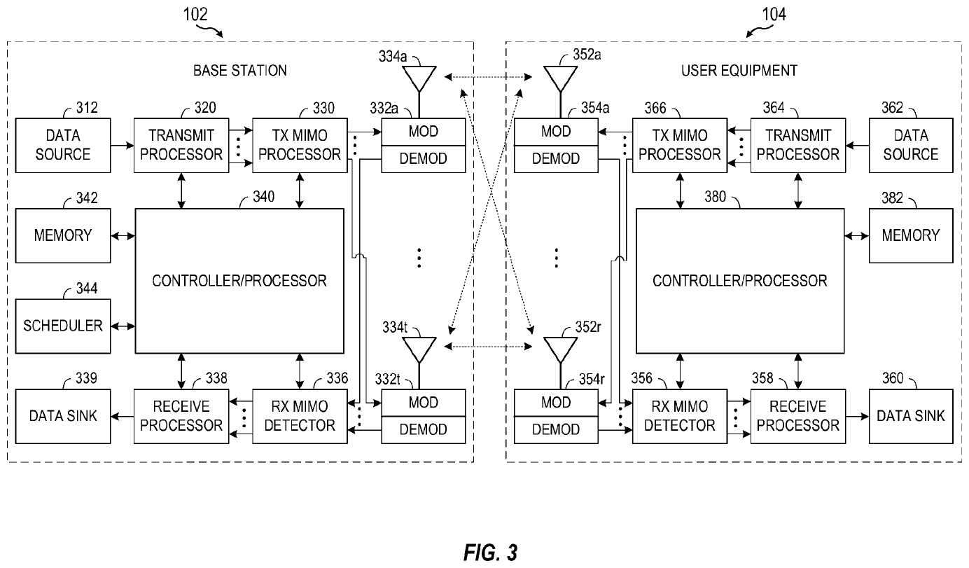

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

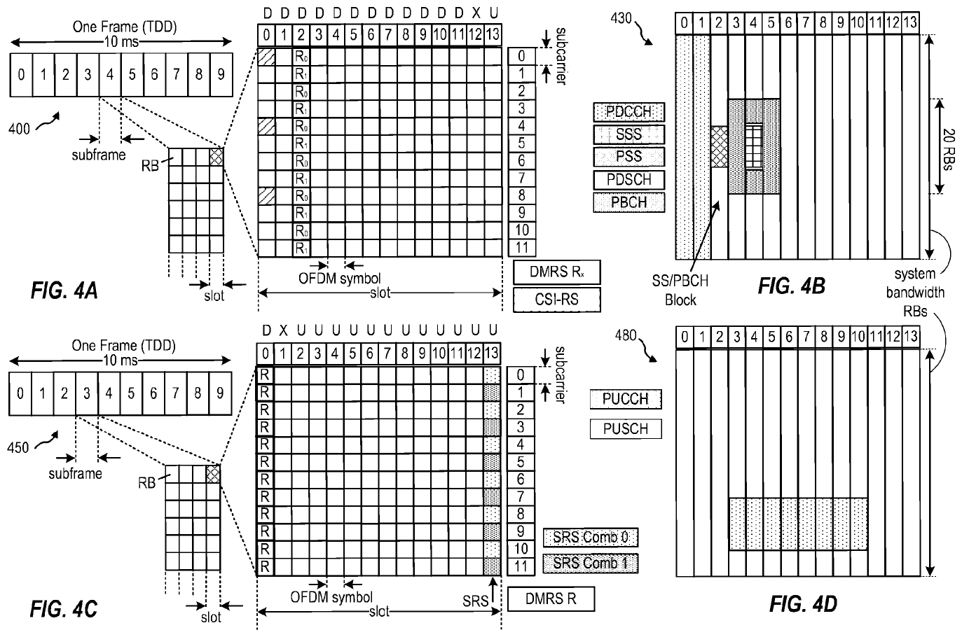

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2 μ slots/subframe. The subcarrier spacing and symbol length/duration are a function of the numerology. The subcarrier spacing may be equal to 2^{μ}×15 kHz, where u is the numerology 0 to 5. As such, the numerology p=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example RACH Procedures

A random-access channel (RACH) is so named because it refers to a wireless channel (medium) that may be shared by multiple UEs and used by the UEs to (randomly) access the network for communications. For example, the RACH may be used for call setup and to access the network for data transmissions. In some cases, RACH may be used for initial access to a network when the UE switches from a radio resource control (RRC) connected idle mode to active mode, or when handing over in RRC connected mode. Moreover, RACH may be used for downlink (DL) and/or uplink (UL) data arrival when the UE is in RRC idle or RRC inactive modes, and when reestablishing a connection with the network.

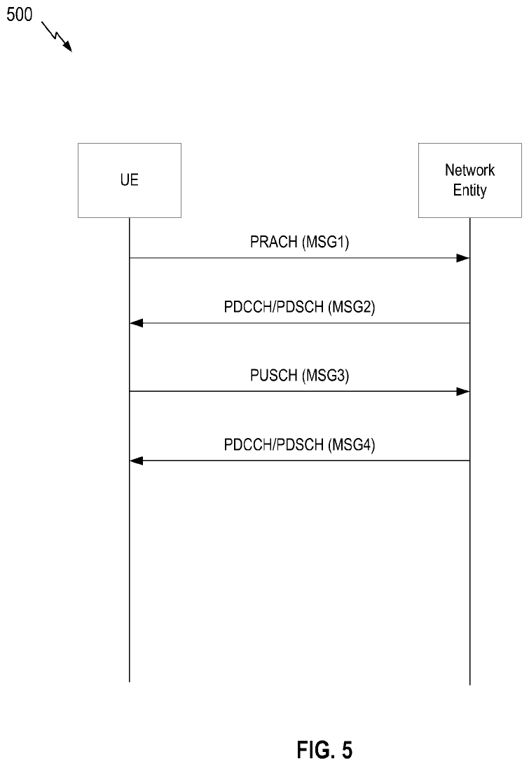

FIG. 5 is a timing (or “call-flow”) diagram 500 illustrating an example four-step RACH procedure, in accordance with certain aspects of the present disclosure. A first message (MSG1) may be sent from the UE to a network entity (e.g., a BS such as a gNB) on the physical random access channel (PRACH). In this case, MSG1 may only include a RACH preamble. The network entity may respond with a random access response (RAR) message (MSG2) which may include the identifier (ID) of the RACH preamble, a timing advance (TA), an uplink grant, cell radio network temporary identifier (C-RNTI), and a back off indicator. MSG2 may include a PDCCH communication including control information for a following communication on the PDSCH, as illustrated. In response to MSG2, MSG3 is transmitted from the UE to the network entity on the PUSCH. MSG3 may include one or more of a RRC connection request, a tracking area update request, a system information request, a positioning fix or positioning signal request, or a scheduling request. The network entity then responds with MSG 4 which may include a contention resolution message.

In some cases, to speed access, a two-step RACH procedure may be supported. As the name implies, the two-step RACH procedure may effectively “collapse” the four messages of the four-step RACH procedure into two messages.

### Overview of Dynamic Signaling-Based Mobility

As noted above, dynamic mobility signaling (e.g., L1 and/or L2-centric mobility or LTM) may lead to more efficient intra-cell and inter-cell mobility with reduced latency.

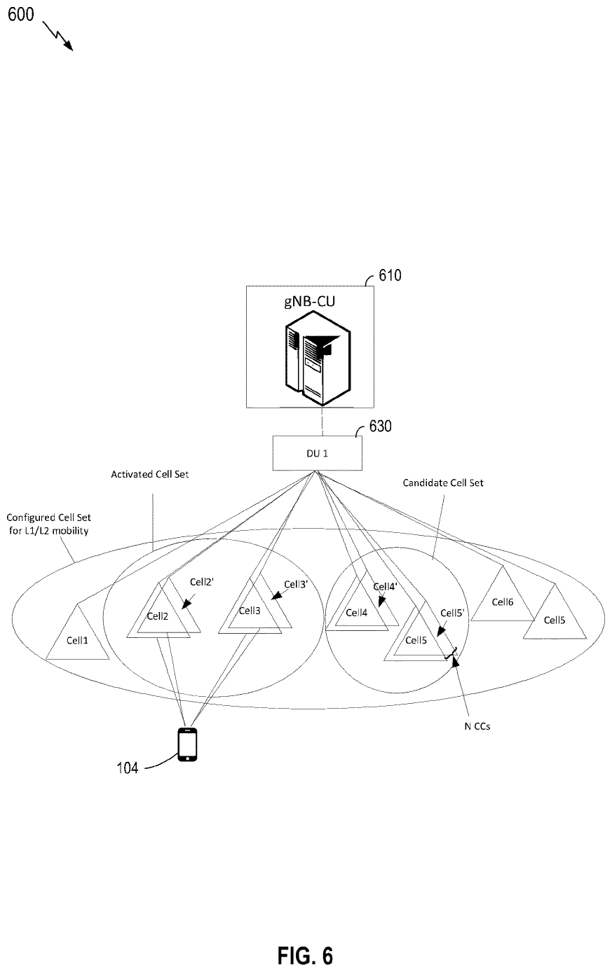

The general concept of LTM signaling may be understood with reference to the example scenario 600 shown in FIG. 6. As illustrated, the network may configure (e.g., via RRC signaling), a set of cells for L1/L2 mobility (referred to herein as an L1/L2 Mobility Configured cell set). At any given time, the network may also configure (via L1/L2 signaling) an L1/L2 Mobility Activated cell set, which refers to a group of cells in the configured set that are activated and can be readily used for data and control transfer. The network may also configure (signal) an L1/L2 Mobility Deactivated cell set, which refers to a group of cells in the configured set that are deactivated and can be readily activated by L1/L2 signaling.

L1/L2 signaling may be used for mobility management of the activated set. For example, L1/L2 signaling may be used to activate/deactivate cells in the set, select beams within the activated cells, and update/switch a primary cell (PCell). This dynamic signaling may help provide seamless mobility within the activated cells in the set. In other words, as the UE moves, the cells from the set are deactivated and activated by L1/L2 signaling. The cells to activate and deactivate may be based on various factors, such as signal quality (measurements) and loading.

As in the example illustrated in FIG. 6, in some cases, all cells in the L1/L2 Mobility Configured cell set may belong to the same DU 630 of a CU 610. This may be similar to carrier aggregation (CA), but cells may be on the same carrier frequencies. The size of the cell set configured for L1/L2 mobility signaling may vary. In general, the cell set size may be selected to be large enough to cover a meaningful mobility area.

In some cases, the UE may be provided with a subset of deactivated cells, as a candidate cell set, from which the UE could autonomously choose to add to the activated cell set. The decision of whether to add a cell from the candidate cell set to the activated cell set may be a based various factors, such as measured channel quality and loading information. In some cases, the ability for the UE to autonomously choose to add to the activated cell set may be similar to a UE decision when configured for Conditional Handover (CHO) for fast and efficient addition of the prepared cells.

As illustrated in FIG. 6, each cell may be served by an RU. Each of the RUs may have multi-carrier (N CCs) support. In such cases, each CC may be a cell (e.g., Cell 2 and Cell 2′ may be different CCs of the same RU). In such cases, activation/deactivation can be done in groups of carriers (cells).

For PCell management, L1/L2 signaling may be used to set (select) the PCell out of the preconfigured options within the activated cell set. In some cases, L3 mobility may be used for PCell change (L3 handover) when a new PCell is not from the activated cell set for L1/L2 mobility. In such cases, RRC signaling may update the set of cells for L1/L2 mobility at L3 handover.

In some cases, physical layer (Layer 1 or L1) measurement may be enhanced for L1/L2 mobility, where a serving cell can be changed via L1/L2 signalling based on L1 measurement, and both synchronous and asynchronous source and target cells may be considered.

Various mechanisms and procedures of L1/L2 based inter-cell mobility may be specified for mobility latency reduction. These may include configuration and maintenance for multiple candidate cells to allow fast application of configurations for candidate cells. Dynamic switching mechanisms among candidate serving cells (including SpCell and SCell) may be supported for the potential applicable scenarios based on L1/L2 signaling.

L1 enhancements for inter-cell beam management, may include L1 measurement and reporting, as well as beam indication. Timing Advance (TA) management and CU-DU interface signaling may also be provided to support L1/L2 mobility.

L1/L2 based inter-cell mobility procedures may be applicable to a variety of scenarios. These scenarios may include standalone, CA and new radio-dual connectivity (NR-DC) cases with serving cell change within one cell group (CG), intra-distributed unit (DU) cases and intra-central unit (CU) inter-DU cases, intra-frequency and inter-frequency scenarios, both FR1 and FR2 scenarios, and scenarios where source and target cells may be synchronized or non-synchronized.

### Overview of PRACH Triggering by DCI

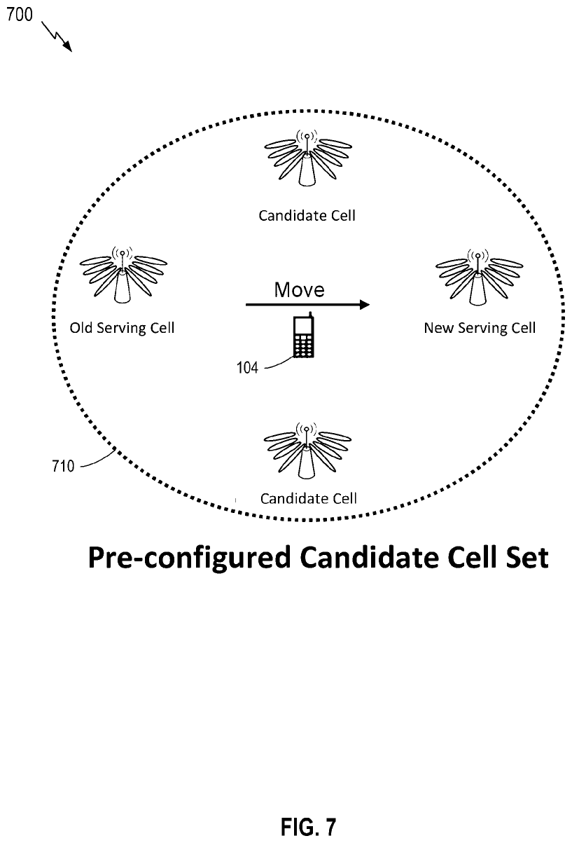

As illustrated in the scenario 700 of FIG. 7, a UE 104 may move between a preconfigured set 710 of candidate cells. In the illustrated example, the UE moves from a first cell (e.g., an old serving/primary cell) to a new serving candidate cell. In this case, the UE may not receive data or control information in the candidate cell, but may transmit a PRACH in order to facilitate timing adjustment for the new candidate cell before a cell change.

PRACH triggering from a network entity may be based on higher layer signaling (e.g., RRC) or, in some cases, lower layer signaling such as a physical downlink control channel (PDCCH).

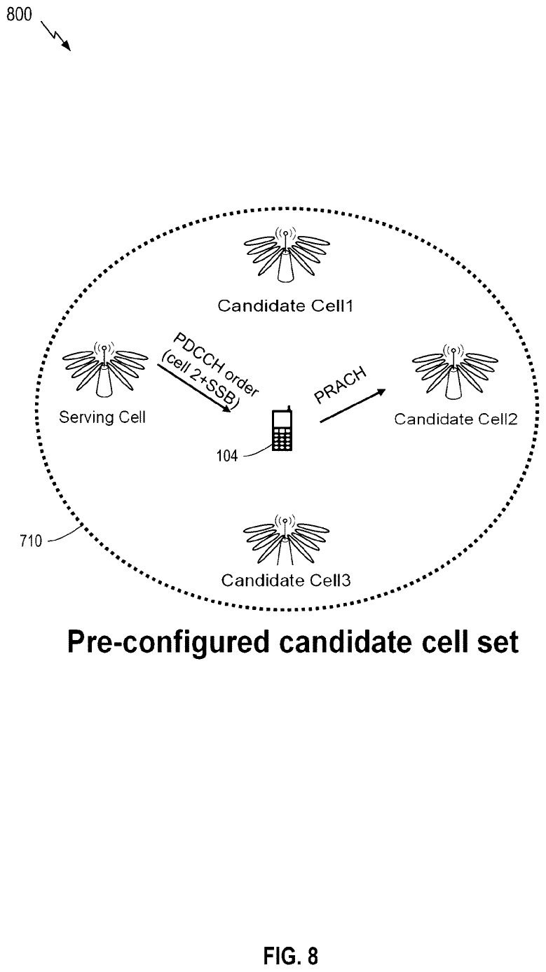

The scenario 800 of FIG. 8, illustrates an example where PRACH transmission from UE 104 for uplink (UL) timing in a candidate cell may be triggered via a PDDCH conveying a downlink control information (DCI) from a serving cell.

In some cases, a RACH may be triggered via a PDCCH. This may be referred to as a PDCCH ordered PRACH transmission. The PDCCH order may be sent by a source cell (current serving) in order to trigger a RACH transmission in a target candidate cell.

The PDCCH order may indicate the target candidate (e.g., Candidate Cell 2 in the illustrated example). As illustrated, the PDCCH order may also indicate (an index of) an SSB that the UE may use as reference for the PRACH transmission. In other words, the UE may transmit the PRACH on (time and frequency resources of) a random access channel (RACH) occasion (RO) associated with the SSB index indicated in the PDCCH order.

### Aspects Related to Ordered Contention Based Random Access for a Candidate Cell

As noted above, in systems that allow only PRACH transmissions triggered via PDCCH order, contention free PRACH transmissions are typically triggered. However, there may be some cases where a contention based random access (CBRA) PRACH transmission would be useful. For example, if a network has less knowledge of an SSB that would be appropriate for a PRACH transmission, it may be beneficial allow a CBRA PRACH, based on a UE selected SSB.

Unfortunately, certain systems may not be configured for a random access response (RAR) used to provide information for contention resolution (e.g., in the event another UE transmits in a same RO). Thus, CBRA PRACH transmissions may have collision issue among different UEs. Aspects of the present disclosure provide techniques for supporting CBRA PRACH transmissions in LTM scenarios. In some cases, contention resolution information may be provided, even in systems not configured for RAR.

In some cases, a UE may obtain a signal (e.g., a PDCCH order) indicating the wireless node is to transmit a physical random access channel (PRACH) to a candidate cell. The UE may outputting the PRACH, for transmission, using resources (e.g., time/frequency resources of an RO) associated with an SS index selected by the UE.

The techniques proposed herein provide for CBRA PRACH transmissions, in a candidate cell, to or from a wireless node. As used herein, the term wireless node generally refers to any type of device capable of wireless communications, such as a UE or a network entity, such as a base station (e.g., a gNB) or entity of a disaggregated base station (e.g., RU, CU or DU). The terms wireless node and wireless device may be used interchangeably.

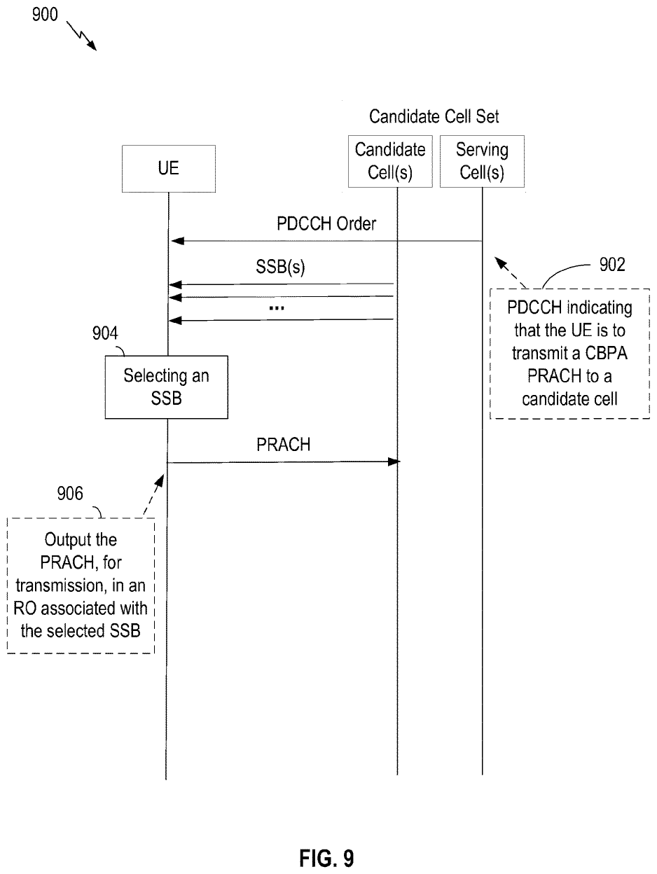

The mechanisms presented herein for triggering CBRA PRACH transmissions in a candidate cell may be understood with reference to the example call flow diagram 900 of FIG. 9.

In some aspects, the UE shown in FIG. 9 may be an example of the UE 104 depicted and described with respect to FIGS. 1 and 3. In some aspects, the candidate cell(s) and/or serving cell(s) shown in FIG. 9 may be controlled via a network entity, which may be an example of the BS 102 (e.g., a gNB) depicted and described with respect to FIGS. 1 and 3 or a disaggregated base station depicted and described with respect to FIG. 2. For example, the candidate and serving cells may be controlled by a DU and/or CU (as illustrated in FIG. 6).

As illustrated at 902, the serving cell may send a PDCCH Order, indicating that the UE is to transmit a CBRA PRACH to a candidate cell. As illustrated, at 904, rather than use an SSB indicated in the PDCCH order to (determine an RO to) send the CBRA PRACH, the UE may select an SSB to use.

As illustrated at 906, the UE may then transmit the PRACH in an RO associated with the UE-selected SSB. The candidate cell may receive the PRACH on time and frequency resources of the RO. In some cases, the network may determine a timing advance (TA) value, based on the PRACH. Providing this information to the UE may help facilitate mobility to the target candidate cell.

In this manner, a UE can be triggered by a DCI (conveyed via a PDCCH order) to transmit a CBRA PRACH for a candidate cell in LTM when the legacy RAR is not configured.

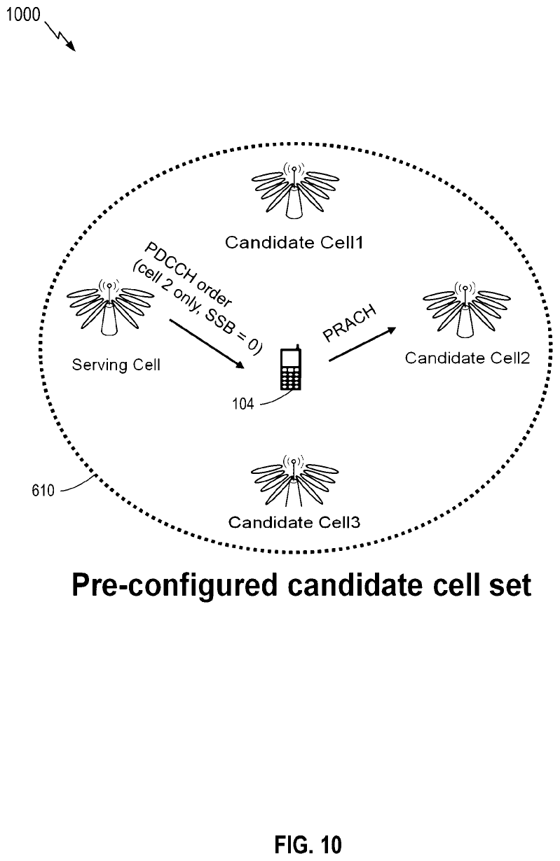

As illustrated in the example scenario 1000 of FIG. 10, in some cases, the PDCCH order for a CBRA PRACH in a candidate cell can be indicated by setting the value of the random access preamble index field for the candidate cell to a certain value (e.g., a value reserved to trigger a CBRA PRACH transmission). For example, in the illustrated example, the random access preamble index field for the candidate cell is set to zero in the PDCCH order.

In some cases, a CBRA PRACH transmission may be triggered by a group common DCI. For example, such a group common DCI may include a dedicated field for a candidate cell that indicates the UE is to transmit a CBRA PRACH for the candidate cell.

According to certain aspects, when a UE is triggered by a DCI with a CBRA PRACH transmission for a candidate cell in LTM, if RAR is not configured for that candidate cell, the UE may still receive a response for contention resolution.

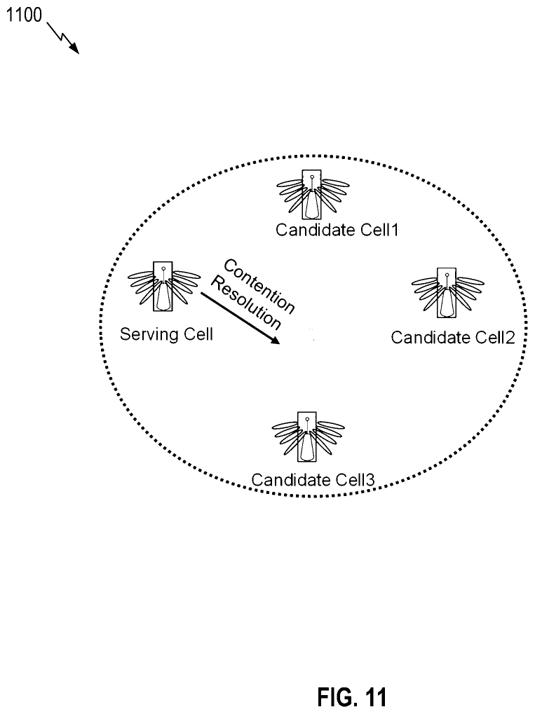

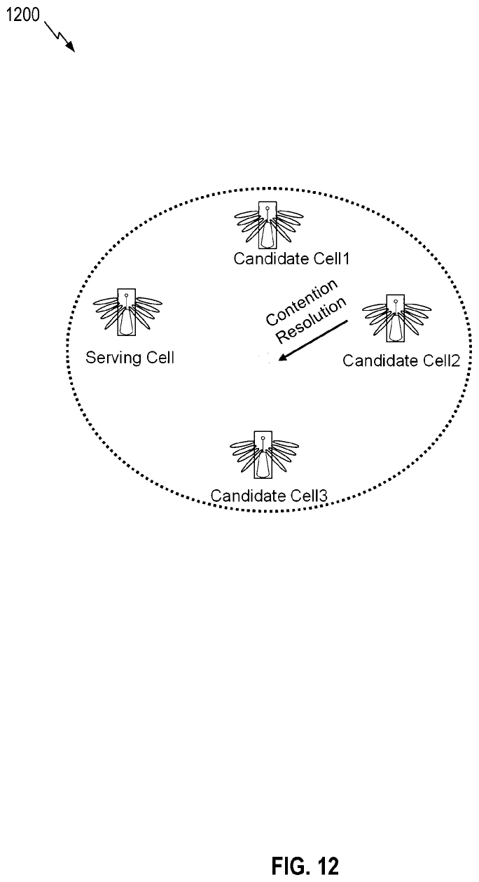

For example, as illustrated in the example scenario 1100 of FIG. 11, the response (with contention resolution information) may be received in a serving cell. As an alternative, or in addition, as illustrated in the example scenario 1200 of FIG. 12, the response (with contention resolution information) may be received in the candidate cell.

The contention resolution response may be transmitted via at least one of: a medium access control (MAC) control element (CE) or a control information. The response may indicate various types of information for contention resolution. For example, the response may indicate at least one of: a UE ID, a timing advance (TA) command, or an SSB index.

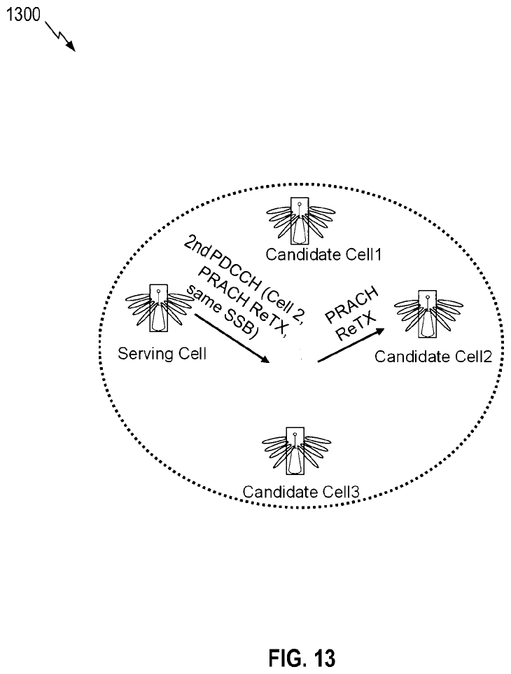

As illustrated in the example scenario 1300 of FIG. 13, in some cases contention resolution information may be conveyed in a second PDCCH order triggering a retransmission of the received CBRA PRACH. The contention resolution information may help in the case that two UEs (UE1 and UE2) transmit a CBRA PRACH in a RO based on a same selected SSB.

For example, a first PDCCH order may trigger a CBRA PRACH for UE1 in a candidate cell. As a response, the UE1 may transmit a CBRA PRACH with a UE selected SSB and RO. UE2 may sometimes transmit a CBRA PRACH in the same RO and SSB which conflicts with the CBRA PRACH transmission from UE1.

As illustrated in FIG. 13, a second PDCCH order may trigger retransmission of the same PRACH, with the same SSB as selected for the initial PRACH transmission.

In some cases, the contention resolution response may be transmitted in a way that UE2 does not receive it. For example, the second PDCCH order may be scrambled by a cell specific radio network temporary identifier (C-RNTI) of UE1.

After retransmitting a PRACH, in response to the second PDCCH, UE 1 may receive a timing adjustment (TA) indication. By utilizing techniques proposed herein, CBRA based PRACH transmissions based on UE selected SSBs may be used, which may improve LTM mobility and quality of experience (QoE) of users.

### Example Operations

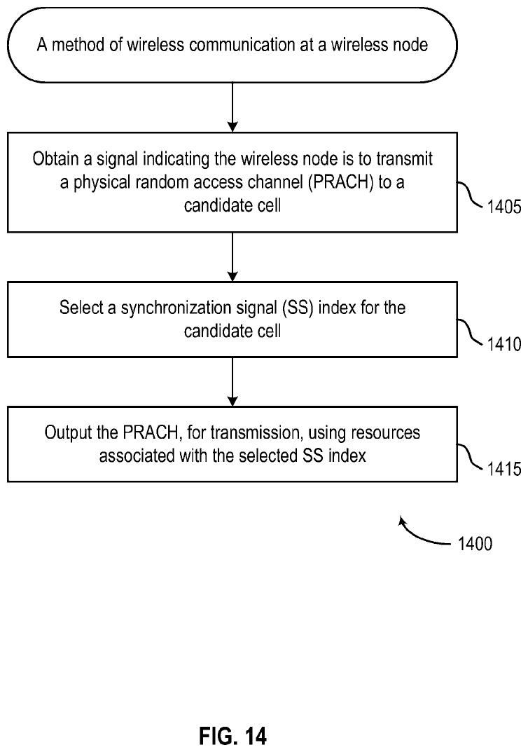

FIG. 14 shows an example of a method 1400 of wireless communication at a wireless node, such as a UE 104 of FIGS. 1 and 3.

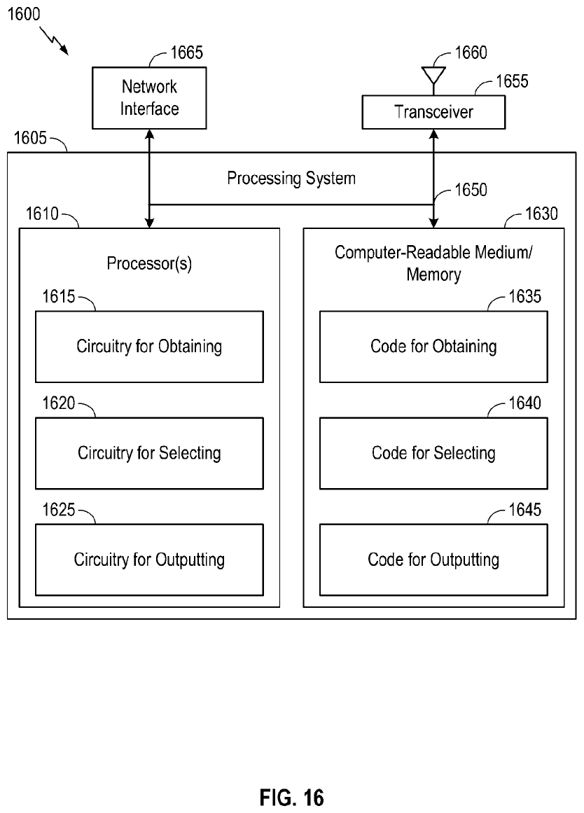

Method 1400 begins at step 1405 with obtaining a signal indicating the wireless node is to transmit a physical random access channel (PRACH) to a candidate cell. In some cases, the operations of this step refer to, or may be performed by, circuitry for obtaining and/or code for obtaining as described with reference to FIG. 16.

Method 1400 then proceeds to step 1410 with selecting a synchronization signal (SS) index for the candidate cell. In some cases, the operations of this step refer to, or may be performed by, circuitry for selecting and/or code for selecting as described with reference to FIG. 16.

Method 1400 then proceeds to step 1415 with outputting the PRACH, for transmission, using resources associated with the selected SS index. In some cases, the operations of this step refer to, or may be performed by, circuitry for outputting and/or code for outputting as described with reference to FIG. 16.

In some aspects, the resources comprise time and frequency resources of a random access channel (RACH) occasion (RO) associated with the selected SS index.

In some aspects, the candidate cell belongs to a set of candidate cells that support mobility signaling via physical (PHY) layer or medium access control (MAC) layer signaling.

In some aspects, the signal comprises a physical downlink control channel (PDCCH) that contains an indication of the candidate cell.

In some aspects, the PDCCH also contains a random access preamble index field set to a value that indicates the wireless node is to transmit the PRACH in the RO associated with the SSB selected by the UE.

In some aspects, the PDCCH conveys a group common control information that indicates the wireless node is to transmit the PRACH using the resources associated with the SS index selected by the wireless node.

In some aspects, the method 1400 further includes obtaining a response to the PRACH, wherein the response indicates information for contention resolution. In some cases, the operations of this step refer to, or may be performed by, circuitry for obtaining and/or code for obtaining as described with reference to FIG. 16.

In some aspects, the response is obtained from at least one of: a serving cell or the candidate cell.

In some aspects, the response is obtained via at least one of: a medium access control (MAC) control element (CE) or a control information.

In some aspects, the response indicates at least one of a UE ID, a timing advance (TA) command, or an SS index.

In some aspects, the method 1400 further includes outputting another PRACH, for transmission, using resources associated with the SS index indicated in the response. In some cases, the operations of this step refer to, or may be performed by, circuitry for outputting and/or code for outputting as described with reference to FIG. 16.

In some aspects, the SS index indicated in the response is the same as the SS index selected by the wireless node.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

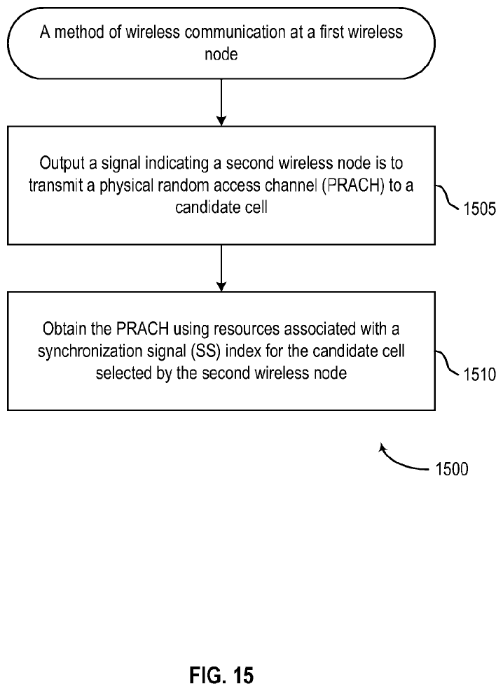

FIG. 15 shows an example of a method 1500 of wireless communication at a first wireless node, such as a BS 102 of FIGS. 1 and 3, or a disaggregated base station as discussed with respect to FIG. 2.

Method 1500 begins at step 1505 with outputting a signal indicating a second wireless node is to transmit a physical random access channel (PRACH) to a candidate cell. In some cases, the operations of this step refer to, or may be performed by, circuitry for outputting and/or code for outputting as described with reference to FIG. 16.

Method 1500 then proceeds to step 1510 with obtaining the PRACH using resources associated with a synchronization signal (SS) index for the candidate cell selected by the second wireless node. In some cases, the operations of this step refer to, or may be performed by, circuitry for obtaining and/or code for obtaining as described with reference to FIG. 16.

In some aspects, the resources comprise time and frequency resources of a random access channel (RACH) occasion (RO) associated with the selected SS index.

In some aspects, the candidate cell belongs to a set of candidate cells that support mobility signaling via physical (PHY) layer or medium access control (MAC) layer signaling.

In some aspects, the signal comprises a physical downlink control channel (PDCCH) that contains an indication of the candidate cell.

In some aspects, the PDCCH also contains a random access preamble index field set to a value that indicates the wireless node is to transmit the PRACH in the RO associated with the SSB selected by the UE.

In some aspects, the PDCCH conveys a group common control information that indicates the wireless node is to transmit the PRACH using the resources associated with the SS index selected by the wireless node.

In some aspects, the method 1500 further includes outputting, for transmission to the second wireless node, a response to the PRACH, wherein the response indicates information for contention resolution. In some cases, the operations of this step refer to, or may be performed by, circuitry for outputting and/or code for outputting as described with reference to FIG. 16.

In some aspects, the response is output from at least one of: a serving cell or the candidate cell.

In some aspects, the response is output via at least one of: a medium access control (MAC) control element (CE) or a control information.

In some aspects, the response indicates at least one of a UE ID, a timing advance (TA) command, or an SS index.

In some aspects, the method 1500 further includes obtaining another PRACH from the second wireless node, using resources associated with the SS index indicated in the response. In some cases, the operations of this step refer to, or may be performed by, circuitry for obtaining and/or code for obtaining as described with reference to FIG. 16.

In some aspects, the SS index indicated in the response is the same as the SS index selected by the wireless node.

In one aspect, method 1500, or any aspect related to it, may be performed by an apparatus, such as communications device 1600 of FIG. 16, which includes various components operable, configured, or adapted to perform the method 1500. Communications device 1600 is described below in further detail.

Note that FIG. 15 is just one example of a method, and other methods including fewer, additional, or alternative steps are possible consistent with this disclosure.

### Example Communications Device(s)

FIG. 16 depicts aspects of an example communications device 1600. In some aspects, communications device 1600 is a user equipment, such as UE 104 described above with respect to FIGS. 1 and 3. In some aspects, communications device 1600 is a network entity, such as BS 102 of FIGS. 1 and 3, or a disaggregated base station as discussed with respect to FIG. 2.

The communications device 1600 includes a processing system 1605 coupled to the transceiver 1655 (e.g., a transmitter and/or a receiver). In some aspects (e.g., when communications device 1600 is a network entity), processing system 1605 may be coupled to a network interface 1665 that is configured to obtain and send signals for the communications device 1600 via communication link(s), such as a backhaul link, midhaul link, and/or fronthaul link as described herein, such as with respect to FIG. 2. The transceiver 1655 is configured to transmit and receive signals for the communications device 1600 via the antenna 1660, such as the various signals as described herein. The processing system 1605 may be configured to perform processing functions for the communications device 1600, including processing signals received and/or to be transmitted by the communications device 1600.

The processing system 1605 includes one or more processors 1610. In various aspects, the one or more processors 1610 may be representative of one or more of receive processor 358, transmit processor 364, TX MIMO processor 366, and/or controller/processor 380, as described with respect to FIG. 3. In various aspects, one or more processors 1610 may be representative of one or more of receive processor 338, transmit processor 320, TX MIMO processor 330, and/or controller/processor 340, as described with respect to FIG. 3. The one or more processors 1610 are coupled to a computer-readable medium/memory 1630 via a bus 1650. In certain aspects, the computer-readable medium/memory 1630 is configured to store instructions (e.g., computer-executable code) that when executed by the one or more processors 1610, cause the one or more processors 1610 to perform the method 1400 described with respect to FIG. 14, or any aspect related to it; and the method 1500 described with respect to FIG. 15, or any aspect related to it. Note that reference to a processor performing a function of communications device 1600 may include one or more processors 1610 performing that function of communications device 1600.

In the depicted example, computer-readable medium/memory 1630 stores code (e.g., executable instructions), such as code for obtaining 1635, code for selecting 1640, and code for outputting 1645. Processing of the code for obtaining 1635, code for selecting 1640, and code for outputting 1645 may cause the communications device 1600 to perform the method 1400 described with respect to FIG. 14, or any aspect related to it; and the method 1500 described with respect to FIG. 15, or any aspect related to it.

The one or more processors 1610 include circuitry configured to implement (e.g., execute) the code stored in the computer-readable medium/memory 1630, including circuitry for obtaining 1615, circuitry for selecting 1620, and circuitry for outputting 1625. Processing with circuitry for obtaining 1615, circuitry for selecting 1620, and circuitry for outputting 1625 may cause the communications device 1600 to perform the method 1400 described with respect to FIG. 14, or any aspect related to it; and the method 1500 described with respect to FIG. 15, or any aspect related to it.

Various components of the communications device 1600 may provide means for performing the method 1400 described with respect to FIG. 14, or any aspect related to it; and the method 1500 described with respect to FIG. 15, or any aspect related to it. For example, means for transmitting, means for sending or means for outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1655 and the antenna 1660 of the communications device 1600 in FIG. 16. Means for receiving or means for obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1655 and the antenna 1660 of the communications device 1600 in FIG. 16. Means for selecting may include any of the various processors and/or transceivers shown in FIG. 3 or 16.

### EXAMPLE CLAUSES

Implementation examples are described in the following numbered clauses:

Clause 1: A method of wireless communication at a wireless node, comprising: obtaining a signal indicating the wireless node is to transmit a physical random access channel (PRACH) to a candidate cell; selecting a synchronization signal (SS) index for the candidate cell; and outputting the PRACH, for transmission, using resources associated with the selected SS index.

Clause 2: The method of Clause 1, wherein the resources comprise time and frequency resources of a random access channel (RACH) occasion (RO) associated with the selected SS index.

Clause 3: The method of any one of Clauses 1-2, wherein the candidate cell belongs to a set of candidate cells that support mobility signaling via physical (PHY) layer or medium access control (MAC) layer signaling.

Clause 4: The method of any one of Clauses 1-3, wherein the signal comprises a physical downlink control channel (PDCCH) that contains an indication of the candidate cell.

Clause 5: The method of Clause 4, wherein the PDCCH also contains a random access preamble index field set to a value that indicates the wireless node is to transmit the PRACH in the resources associated with the SS index.

Clause 6: The method of Clause 4, wherein the PDCCH conveys a group common control information that indicates the wireless node is to transmit the PRACH using the resources associated with the SS index selected by the wireless node.

Clause 7: The method of any one of Clauses 1-6, further comprising: obtaining a response to the PRACH, wherein the response indicates information for contention resolution.

Clause 8: The method of Clause 7, wherein the response is obtained from at least one of: a serving cell or the candidate cell.

Clause 9: The method of Clause 7, wherein the response is obtained via at least one of: a medium access control (MAC) control element (CE) or a control information.

Clause 10: The method of Clause 7, wherein the response indicates at least one of a UE ID, a timing advance (TA) command, or an SS index.

Clause 11: The method of Clause 10, further comprising outputting another PRACH, for transmission, using resources associated with the SS index indicated in the response.

Clause 12: The method of Clause 10, wherein the SS index indicated in the response is the same as the SS index selected by the wireless node.

Clause 13: A method of wireless communication at a first wireless node, comprising: outputting a signal indicating a second wireless node is to transmit a physical random access channel (PRACH) to a candidate cell; and obtaining the PRACH using resources associated with a synchronization signal (SS) index for the candidate cell selected by the second wireless node.

Clause 14: The method of Clause 13, wherein the resources comprise time and frequency resources of a random access channel (RACH) occasion (RO) associated with the selected SS index.

Clause 15: The method of any one of Clauses 13-14, wherein the candidate cell belongs to a set of candidate cells that support mobility signaling via physical (PHY) layer or medium access control (MAC) layer signaling.

Clause 16: The method of any one of Clauses 13-15, wherein the signal comprises a physical downlink control channel (PDCCH) that contains an indication of the candidate cell.

Clause 17: The method of Clause 16, wherein the PDCCH also contains a random access preamble index field set to a value that indicates the wireless node is to transmit the PRACH in the resources associated with the SS index.

Clause 18: The method of Clause 16, wherein the PDCCH conveys a group common control information that indicates the wireless node is to transmit the PRACH using the resources associated with the SS index.

Clause 19: The method of any one of Clauses 13-18, further comprising: outputting, for transmission to the second wireless node, a response to the PRACH, wherein the response indicates information for contention resolution.

Clause 20: The method of Clause 19, wherein the response is output from at least one of: a serving cell or the candidate cell.

Clause 21: The method of Clause 19, wherein the response is output via at least one of: a medium access control (MAC) control element (CE) or a control information.

Clause 22: The method of Clause 19, wherein the response indicates at least one of a UE ID, a timing advance (TA) command, or an SS index.

Clause 23: The method of Clause 22, further comprising obtaining another PRACH from the second wireless node, using resources associated with the SS index indicated in the response.

Clause 24: The method of Clause 22, wherein the SS index indicated in the response is the same as the SS index selected by the wireless node.

Clause 25: An apparatus, comprising: a memory comprising executable instructions; and a processor configured to execute the executable instructions and cause the apparatus to perform a method in accordance with any one of Clauses 1-24.

Clause 26: An apparatus, comprising means for performing a method in accordance with any one of Clauses 1-24.

Clause 27: A non-transitory computer-readable medium comprising executable instructions that, when executed by a processor of an apparatus, cause the apparatus to perform a method in accordance with any one of Clauses 1-24.

Clause 28: A computer program product embodied on a computer-readable storage medium comprising code for performing a method in accordance with any one of Clauses 1-24.

Clause 29: A user equipment (UE), comprising: at least one transceiver, a memory comprising executable instructions; and a processor configured to execute the executable instructions and cause the UE to perform a method in accordance with any one of Clauses 1-12, wherein the at least one transceiver is configured to at least one of receive the signal or transmit the PRACH.

Clause 30: A network entity, comprising: at least one transceiver, a memory comprising executable instructions; and a processor configured to execute the executable instructions and cause the network entity to perform a method in accordance with any one of Clauses 13-24, wherein the at least one transceiver is configured to at least one of transmit the signal or receive the PRACH.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications, comprising:
at least one memory comprising executable instructions; and
one or more processors configured to execute the executable instructions and cause the apparatus to:
obtain a signal indicating the apparatus is to transmit a physical random access channel (PRACH) to a candidate cell;
select a synchronization signal (SS) index for the candidate cell; and
output the PRACH, for transmission, using resources associated with the selected SS index.

2. The apparatus of claim 1, wherein the resources comprise time and frequency resources of a random access channel (RACH) occasion (RO) associated with the selected SS index.

3. The apparatus of claim 1, wherein the candidate cell belongs to a set of candidate cells that support mobility signaling via physical (PHY) layer or medium access control (MAC) layer signaling.

4. The apparatus of claim 1, wherein the signal comprises a physical downlink control channel (PDCCH) that contains an indication of the candidate cell.

5. The apparatus of claim 4, wherein the PDCCH also contains a random access preamble index field set to a value that indicates the apparatus is to transmit the PRACH in the resources associated with the SS index selected by the apparatus.

6. The apparatus of claim 4, wherein the PDCCH conveys a group common control information that indicates the apparatus is to transmit the PRACH using the resources associated with the SS index selected by the apparatus.

7. The apparatus of claim 1, wherein the one or more processors are further configured to execute the executable instructions and cause the apparatus to:
obtain a response to the PRACH, wherein the response indicates information for contention resolution.

8. The apparatus of claim 7, wherein the response is obtained from at least one of: a serving cell or the candidate cell.

9. The apparatus of claim 7, wherein the response is obtained via at least one of:
a medium access control (MAC) control element (CE) or a control information.

10. The apparatus of claim 7, wherein the response indicates at least one of:
a user equipment (UE) ID;
a timing advance (TA) command; or
an SS index.

11. The apparatus of claim 10, wherein the one or more processors are further configured to execute the executable instructions and cause the apparatus to output another PRACH, for transmission, using resources associated with the SS index indicated in the response.

12. The apparatus of claim 10, wherein the SS index indicated in the response is the same as the SS index selected by the apparatus.

13. (canceled)

14. An apparatus for wireless communications, comprising:
at least one memory comprising executable instructions; and
one or more processors configured to execute the executable instructions and cause the apparatus to:
output a signal indicating a wireless node is to transmit a physical random access channel (PRACH) to a candidate cell; and
obtain the PRACH using resources associated with a synchronization signal (SS) index for the candidate cell selected by the wireless node.

15. The apparatus of claim 14, wherein one of:
the resources comprise time and frequency resources of a random access channel (RACH) occasion (RO) associated with the SS index; and
the candidate cell belongs to a set of candidate cells that support mobility signaling via physical (PHY) layer or medium access control (MAC) layer signaling.

16. (canceled)

17. The apparatus of claim 14, wherein the signal comprises a physical downlink control channel (PDCCH) that contains an indication of the candidate cell.

18. The apparatus of claim 17, wherein one of:
the PDCCH also contains a random access preamble index field set to a value that indicates the wireless node is to transmit the PRACH in the resources associated with the SS index; and
the PDCCH conveys a group common control information that indicates the wireless node is to transmit the PRACH using the resources associated with the SS index selected by the wireless node.

19. (canceled)

20. The apparatus of claim 14, wherein the one or more processors are further configured to execute the executable instructions and cause the apparatus to:
output, for transmission to the wireless node, a response to the PRACH, wherein the response indicates information for contention resolution.

21. The apparatus of claim 20, wherein one of:
the response is output from at least one of: a serving cell or the candidate cell;
the response is output via at least one of: a medium access control (MAC) control element (CE) or a control information; and
the response indicates at least one of a user equipment (UE) ID, a timing advance (TA) command, or an SS index.

22-23. (canceled)

24. The apparatus of claim 23, wherein one of:
the one or more processors are further configured to execute the executable instructions and cause the apparatus to obtain another PRACH from the wireless node, using resources associated with the SS index indicated in the response; and
the SS index indicated in the response is the same as the SS index selected by the wireless node.

25-26. (canceled)

27. A method of wireless communication at a wireless node, comprising:
obtaining a signal indicating the wireless node is to transmit a physical random access channel (PRACH) to a candidate cell;
selecting a synchronization signal (SS) index for the candidate cell; and
outputting the PRACH, for transmission, using resources associated with the selected SS index.
